(19) United States
(12) Patent Application Publication
(10) Pub. No.: US 2002/0085514 A1
(43) Pub. Date: Jul. 4, 2002

(54) Method for switching between high-speed packet data service option and non-high-speed circuit switched or packet data service options without disrupting user data flow

(76) Inventors: William E. Illidge, Kanata (CA); James R. Weisert, Calgary (CA)

Correspondence Address: SMART & BIGGAR, P.O. BOX 2999, STATION D, 55 METCALFE STREET, SUITE 900, OTTAWA, ON, K1P5Y6, CA

(21) Appl. No.: 09/749,592

(22) Filed: Dec. 28, 2000

(51) Int. Cl. H04L 12/56

(52) U.S. Cl. 370/329; 370/352; 370/401

(57) ABSTRACT

A method of moving from a 3G CDMA data session to a 2G circuit switched data session. The high-speed packet data service option of IS-2000 (3G) does not support the older low-speed IS-95 traffic channels (2G). When a mobile station, having an established high-speed packet data service call, moves from an area of 3G coverage to an area where only 2G coverage is available or where mixed 2G/3G coverage is available and the 3G coverage is congested, the call is switched from a 3G IS-2000 high-speed packet data service call to an IS-95 circuit switched data service call or an IS-707-A-5 low-speed packet data service option. The 3G call may also be terminated and re-established as an 2G call re-routed using Mobile IP.

### FIELD

This invention relates to CDMA (code division multiple access) data communication.

### BACKGROUND

Mobile communication systems in North America are making the transition from second generation (2G) non-high-speed systems based on the IS-95 (Telecommunication Industry Association (TIA) interim standard number 95) standard to third generation (3G) high-speed systems based on IS-2000 (TIA interim standard 2000). It is expected that, especially in the early days of IS-2000 deployment, operators may concentrate on providing IS-2000 coverage (and, consequently, high-speed packet data service) in their highest traffic areas, leaving largely IS-95-only coverage areas in their networks in which they are unable to provide the high-speed packet data service option. Effectively, their networks are expected to have non-contiguous pockets of high-speed packet data coverage. However, the high-speed packet data service option in IS-2000 does not support non-IS-2000 physical channels.

Mobile communication system operators would like to provide their mobile packet data users with seamless coverage throughout their network. However, because the high-speed packet data service option does not support the older non-high-speed IS-95 traffic channels, a user crossing the boundary of IS-2000 coverage will not be able to retain the high-speed packet data service option. Consequently, the entire packet data session will be terminated or put on hold netting loss of service.

If the user wants to continue Internet access after moving from an IS-2000 coverage pocket to an IS-95 coverage pocket or a mixed IS-2000/IS-95 pocket where the IS-2000 service is congested, he/she would have to establish a new call manually. This can result in significant data loss. In many cases, the user's applications will not survive this interruption, and the users themselves will have to manually re-initialize or restart.

### SUMMARY

This invention provides a method whereby the operator's network infrastructure can continue to offer the user daft service outside the IS-2000 (3G) coverage area without requiring manual user intervention. Data loss is minimized or eliminated, thereby insuring that the user's data applications are not disturbed when moving from an IS-2000 (3G) coverage area to an IS-95-only (2G) area.

According to a first broad aspect, the invention provides in a CDMA communications system, a method for switching a 3G packet data call to a 2G circuit switched data call, the method comprising the steps of: identifying a mobile station that is exiting an area of 3G coverage and entering an area of 2G coverage; negotiating service options between the mobile and a base station controller; and switching from a 3G packet data service option to a 2G circuit switched data service option.

According to a second broad aspect, the invention provides in a CDMA communications system, A method for switching a 3G packet data call to a 2G packet data call, the method comprising the steps of: identifying a mobile station that is exiting an area or 3G coverage and entering an area of 2G coverage; negotiating service options between the MS and the BSC; modifying the R-P interface; and switching from 3G high-speed packet data service option to a non-high-speed packet data service option.

Other aspects and features of the present invention will become apparent to those ordinarily skilled in the art upon review of the following description of the specific embodiments of the invention in conjunction with the accompanying figures.

### BRIEF DESCRIPTION OF THE DRAWINGS

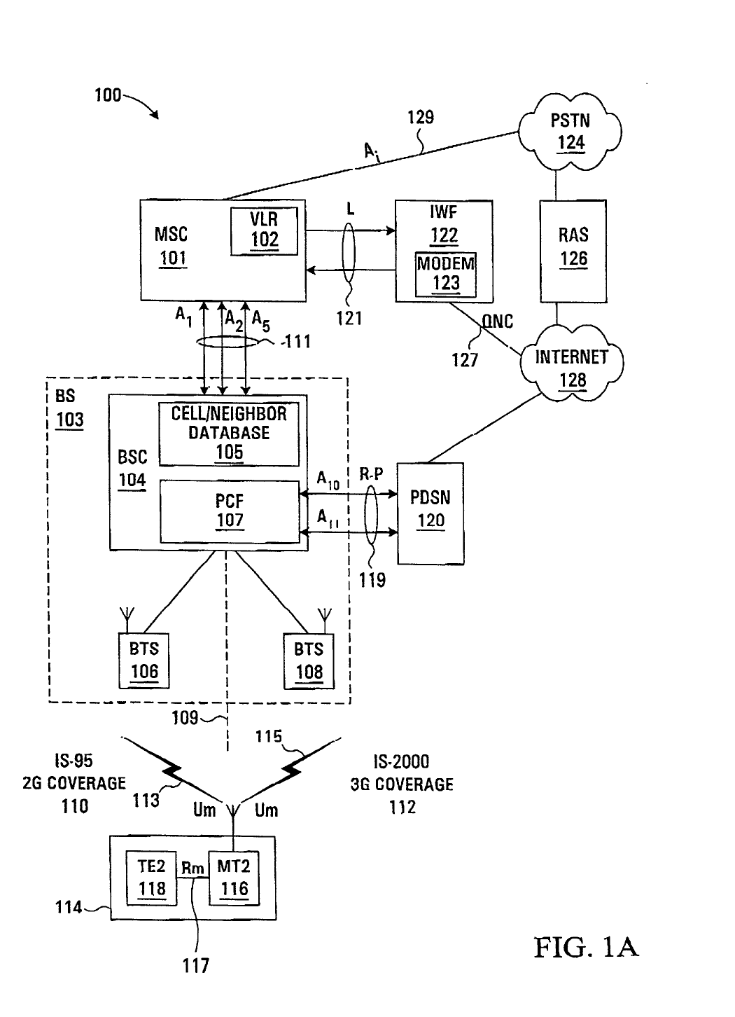

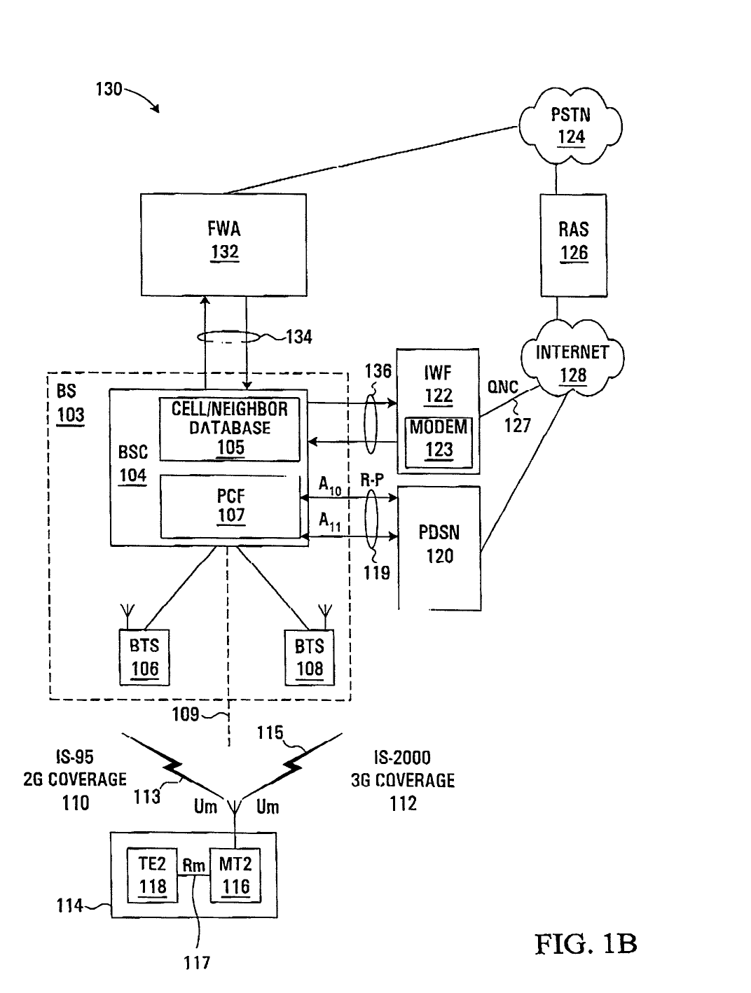

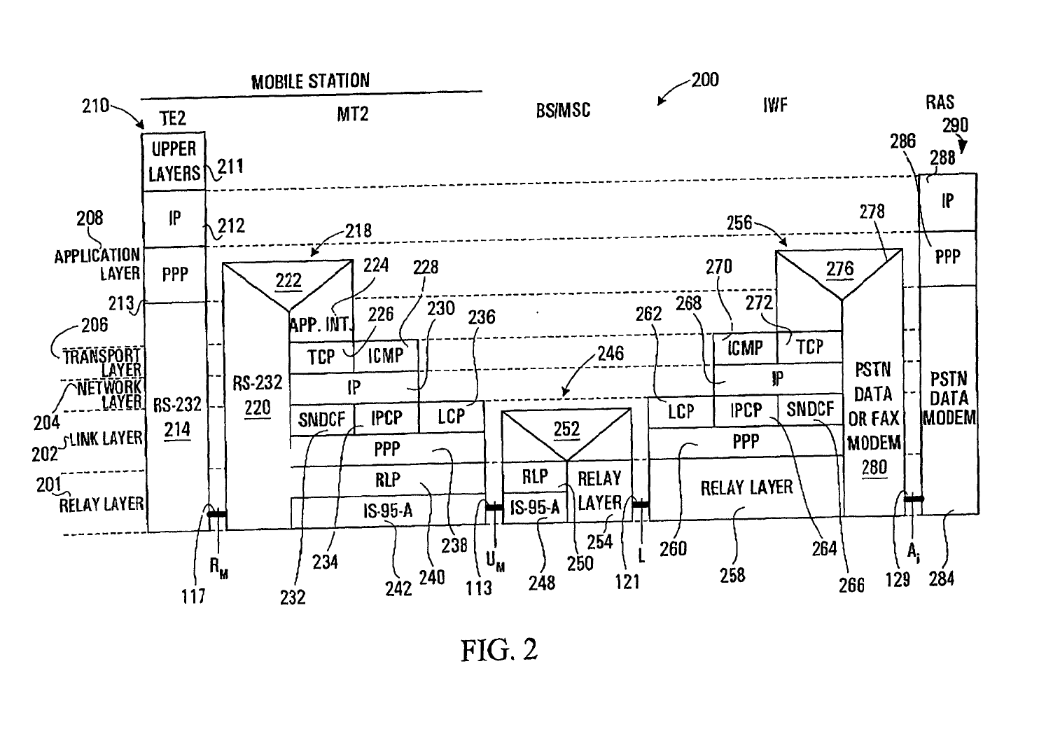

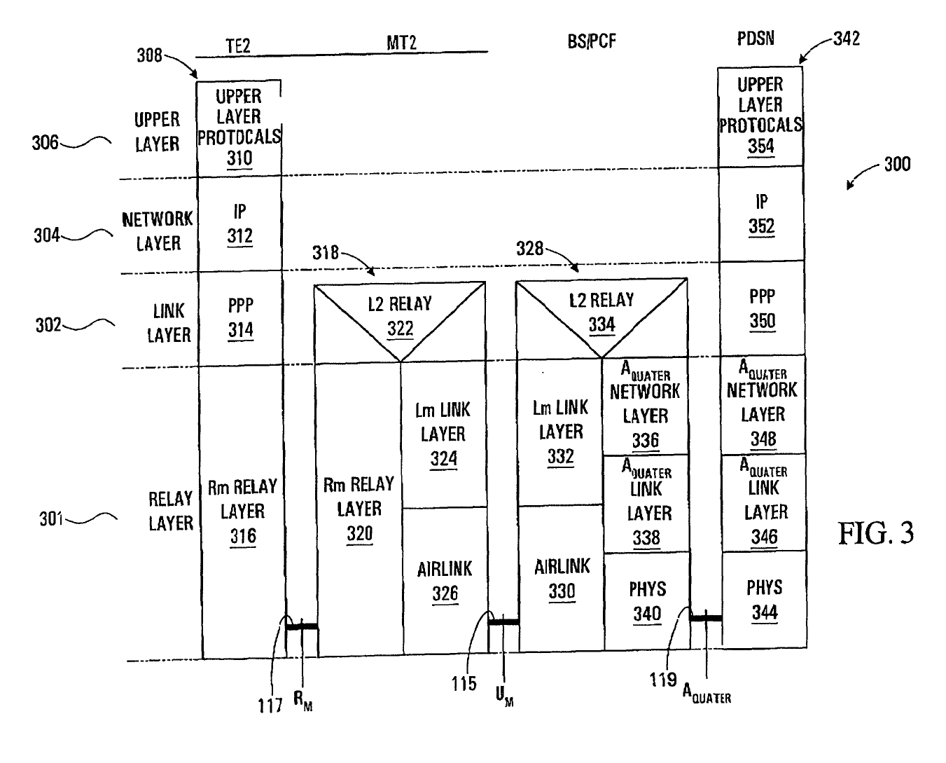

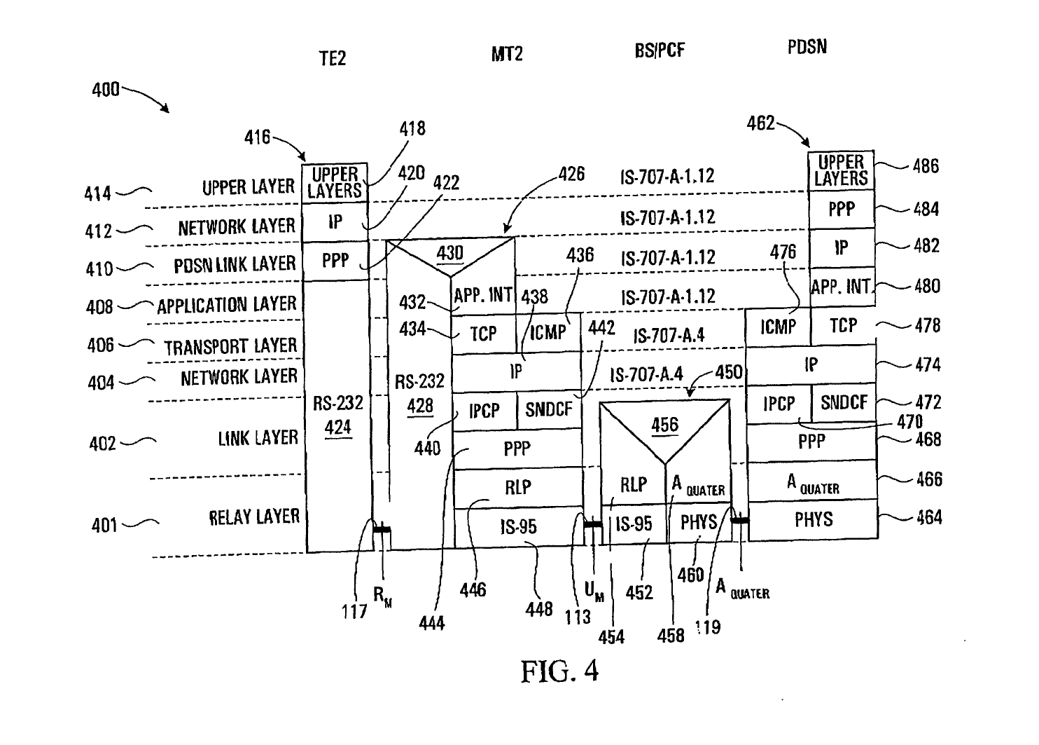

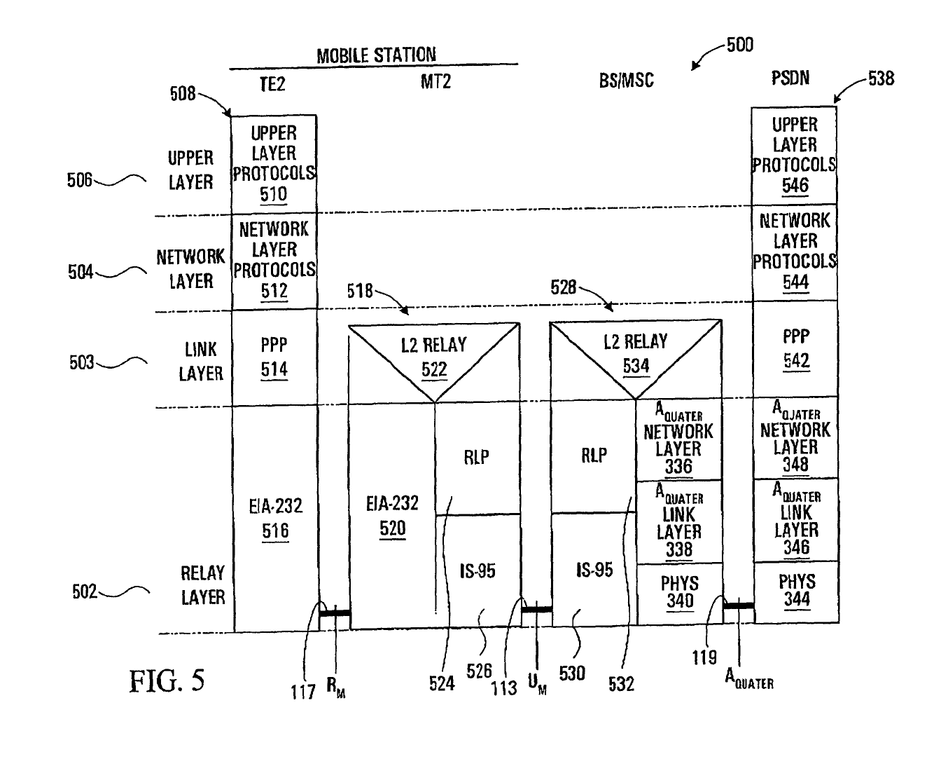

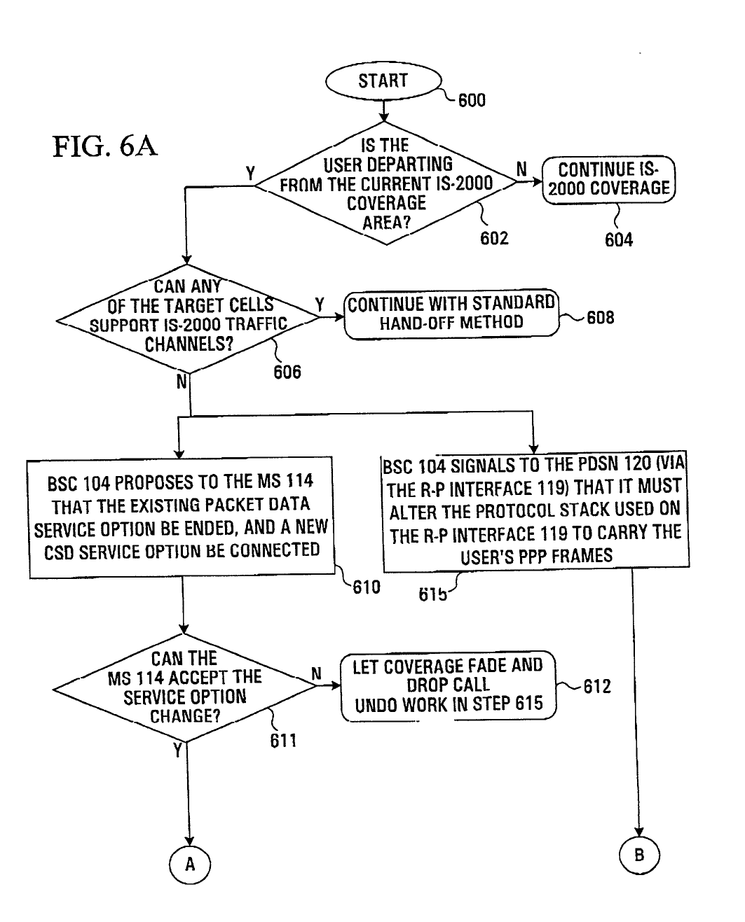

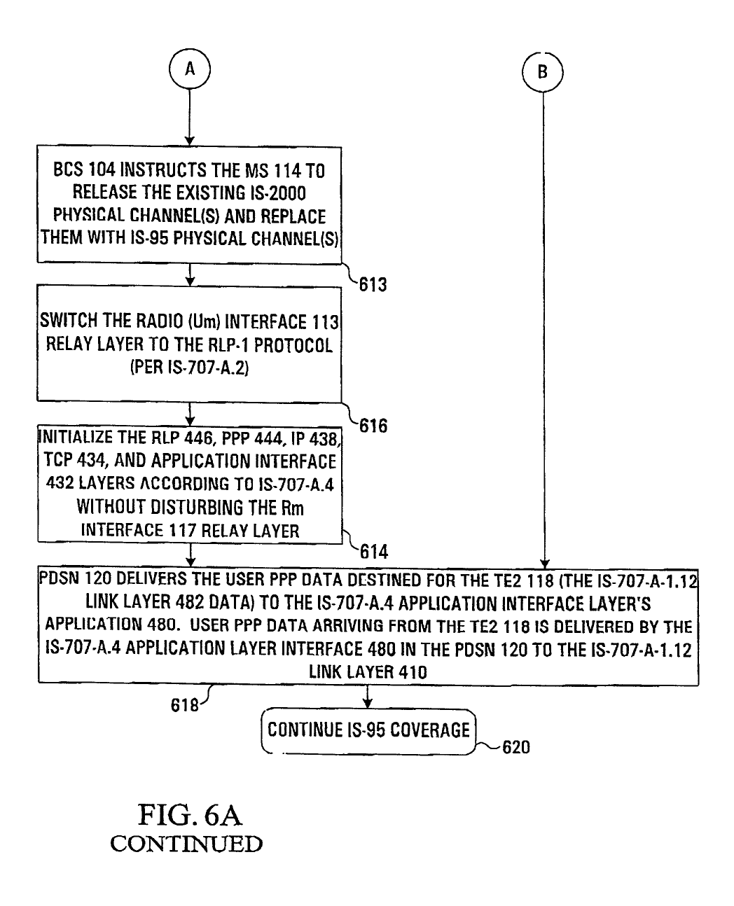

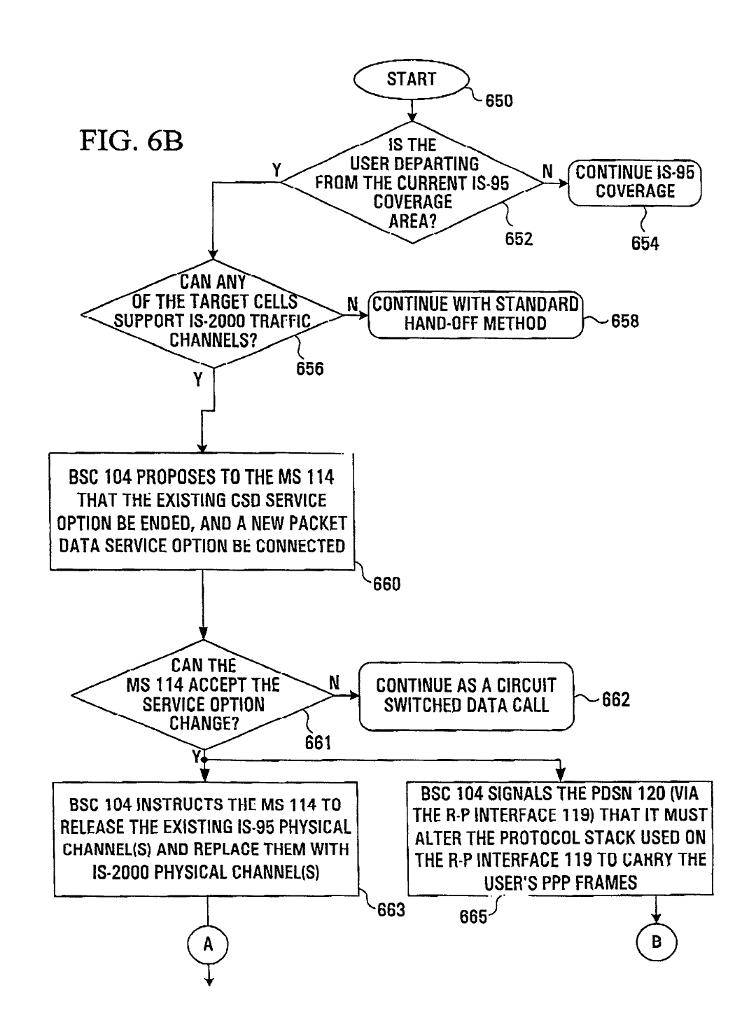

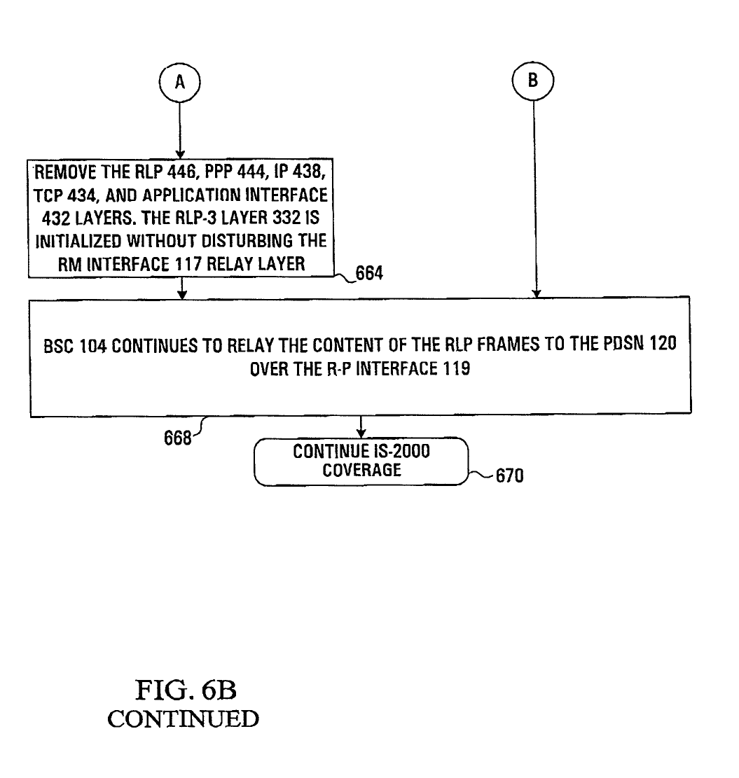

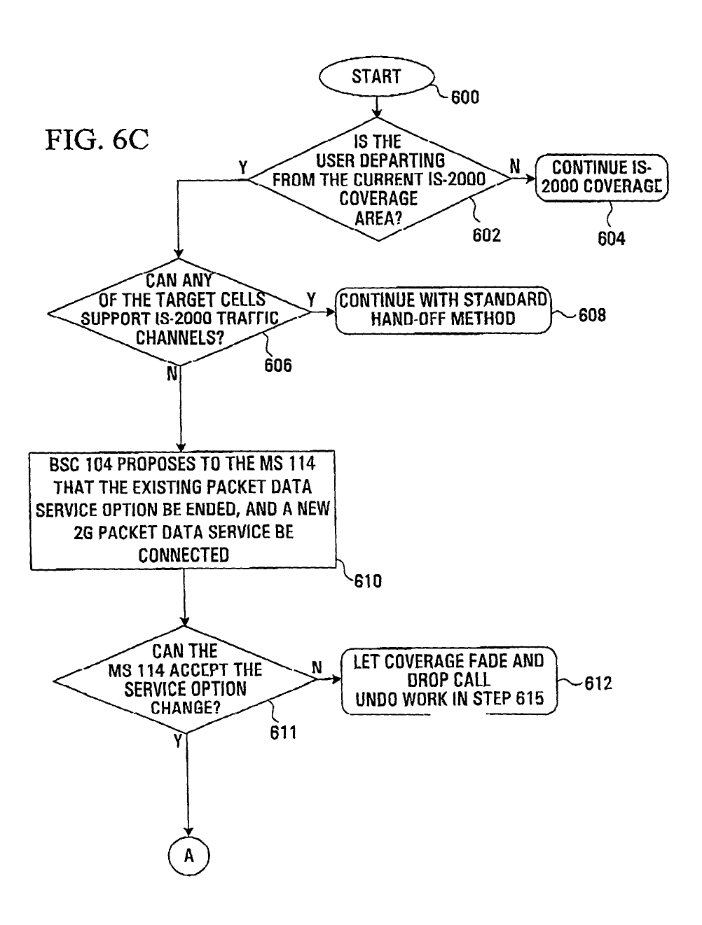

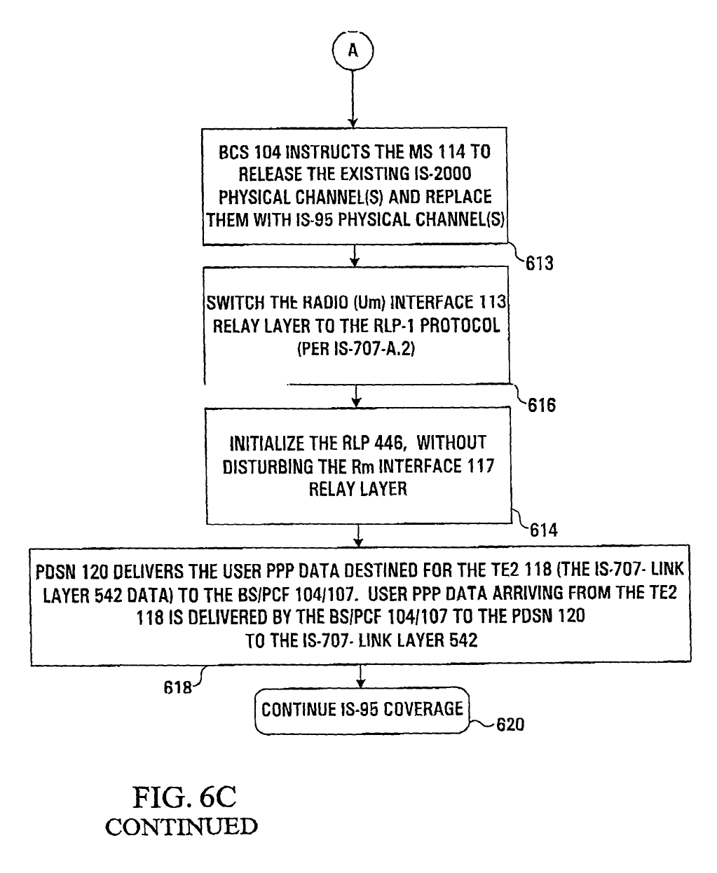

In the accompanying drawings that illustrate embodiments of the invention, FIG. 1A and 1B are a block diagrams of two different CDMA communications systems; FIG. 2 is a diagram of an IS-95 protocol stack for a circuit switched data session; FIG. 3 is a diagram of an IS-2000 protocol stack for a packet data session; FIG. 4 is a diagram of the protocol stack used in the preferred embodiment of the invention; FIG. 5 is a diagram of the protocol stack used in alternative embodiment of the invention; FIG. 6A is a flowchart showing the execution of the preferred embodiment of the invention; FIG. 6B is a flowchart showing the reverse execution of the preferred embodiment of the inventions and FIG. 6C is a flowchart showing the execution of an alternative embodiment of the invention.

### DESCRIPTION OF THE PREFERRED EMBODIMENTS

Referring to FIG. 1A, a preferred architecture of a mixed 2G and 3G CDMA mobile communication system 100 includes a plurality of MSCs (mobile switching centres) 101 (only one shown). Each MSC 101 is connected to a plurality of BSs (base stations) 103 (only one shown) via an A₁, A₂ and A₅ interfaces 111. Each BS 103 comprises a BSC (base station controller) 104 and A plurality of BTSs (base station transceivers) 106,108 (only two shown). The BSC 104 has a cell/neighbor database 105 and a PCF (packet control function) 107. The BTSs 106,108 communicate via over-the-air Uₘ interfaces 113,115 respectively with a plurality of MSs (mobile stations) 114 (Only one shown). In this example, for convenience, BTS 106 is a non-high-speed data 2G base station providing IS-95 coverage in area 110 (via Uₘ interface 113) and BTS 108 is a high-speed data 3G base station providing IS-2000 coverage in area 112 (via Uₘ interface 115); the areas or cells covered by BTS 106 and BTS 108 are adjacent and separated by a coverage boundary 109. However, in reality, the coverage areas may be mixed IS-95/IS2000 coverage areas or overlapping areas and still be within the scope of this invention. Each MSC 101 has a VLR (visitor location registry) 102 containing information regarding all MSS 114. The VLR 102 may be internal or external to the MSC 101. Each MS 114 comprises an MT2 (mobile terminal) 116 and TE2 (terminal equipment) 118 interconnected via an Rₘ (the interface between a TE2 and an MT2 ) interface 117. The BSC 104 is connected via an R-P (PCF (packet control function) radio side to PDSN (packet data serving node) packet data side) interface 119 to a PDSN 120 that is connected to the Internet 128. The MSC 101 is connected via an L-interface (IWF-serving MSC to BSC) 121 to an IWF (interworking function) 122 that is also connected to the Internet 128 via a QNC (Quick Network Connect or Fast Connect) link 127. The IWF 122 has a plurality of modems 123 (only one shown) connected to the L-interface 121. Alternatively, the IWF 122 can be connected to the BSC 104 (not shown). The MSC 101 is also connected to the PSTN (public switched telephone network) 124 via an Aᵢ interface 129. A RAS (remote access server) 126 provides a connection between the PSTN 124 and the Internet 128.

Referring to FIG. 1B, an alternative architecture of a mixed 2G and 3G CDMA mobile communication system 130 includes a plurality of FWA (fixed wireless access), where an IWF is located at the BSC switches 132 (only one shown). Each FWA switch 132 is connected via link 134, that may be, for example, ITU-T V5.2 or Bellcore TR-303, to a plurality of BSs 103 (only one shown). Each BS 103 comprises a BSC 104 and a plurality of BTSs 106,108 (only two shown). The BSC 104 has a cell/neighbor database 105 and a PCF 107. The BTSs 106, 108 communicate via over-the-air Uₘ interfaces 113, 115 respectively with a plurality of MSs 114 (only one shown). In this example, for convenience, BTS 106 is a 2G base station providing IS-95 coverage in area 110 (via Uₘ interface 113) and BTS 108 is a 3G base station providing IS-2000 coverage in area 112 (via Uₘ interface 115); the areas or cells covered by BTS 106 and BTS 108 are adjacent and separated by a coverage boundary 109. However, in reality, the coverage areas may be mixed IS-95/IS-2000 coverage areas or overlapping areas and still be within the scope of this invention. Each MS 114 comprises a MT2 116 and TE2 118 that are interconnected via an Rₘ interface 117. The BSC 104 is connected via an R-P interface 119 to a PDSN 120. The BSC 104 is also connected via an IWF/BSC interface 136 to an IWF 122 that is connected to the internet via a QNC link 127. The IWF 122 has a plurality of modems 123 (only one shown) connected to the IWF/BSC interface 136. The FWA switch 132 is also connected to the PSTN 124. A RAS 126 provides a connection between the PSTN 124 and the Internet 128.

The most widespread method of providing Internet access in a CDMA cellular network is based on the IS-707 (Telecommunications Industry Association (TIA) interim standard title: “Data Services Options for Spread Spectrum Systems”), IS-95 (TIA interim standard title: “Mobile Station-Base Station Compatibility Standard for Wideband Spread Spectrum Cellular Systems”) and IS-99 (TIA interim Standard title: “Data Services Option Standard for Wideband Spread Spectrum Digital Cellular System”) standards for a circuit-switched data (CSD) service option. These standards are incorporated by reference herein. This service provides the user with data and fax at rates up to 14.4 kbps. Specifically, CDMA supports data rates at 0.6 kbs and 14.4 kbs and Fax at the same rates. In the architecture shown in FIG. 1A, the MSC 101 circuit switches data from the MS/BSC 114, 104 to the IWF 122. The IWF 122 is anchored at the MSC 101 or, alternatively, it may be anchored at the BSC 104 (not shown). In the IWF 122, a modem 123 provides modulated data to the PSTN 124 through the MSC 101 for connection to the RAS 126.

In the alternative architecture shown in FIG. 1B, the FWA switch 132 switches data from the MS/BSC 114, 104 to the PSTN 124. The IWF 112 is anchored at the BSC 104. Since there is no modem in the MS 114 and the FWA switch 132 does not understand wireless data, the call is routed through the IWF 122 to be modulated/demodulated by the modems 123. The BSC 104 appears as a normal trunk peripheral to the FWA switch 132. Alternatively in the IWF 112 for a QNC/Fast Connect 127 Call, the data can be sent directly to the Internet 128 bypassing the modem 123 in the IWF 122.

Referring to FIG. 2, a protocol stack model for a 2G CDMA mobile communication system providing circuit switched data services in which a mobile user accesses the Internet via a remote access server 200 comprises a TE2 protocol stack 210, an MT2 protocol stack 218, a BS/MSC protocol stack 246, an IWF protocol stack 256 and a RAS stack 290. The protocol stack model for a 2G CDMA mobile communication system providing circuit switched data services in which a mobile user accesses the Internet via a remote access server 200 also comprises a relay layer 201, a link layer 202, a network layer 204, a transport layer 206 and an application layer 208. The TE2 protocol stack 210 comprises upper layer protocols 211, IP 212, PPP 213, on the application layer 208 and RS-232 214. The MT2 protocol stack 218 comprises RS-232 220; an MT2 relay 222 and An application interface 224 on the application layer 208; TCP (transport control protocol) 226 and ICMP (internet control message protocol) 228 on the transport layer 206; IP (internet protocol) 230 on the network layer 204; SNDCF (sub networkdependent convergence protocol) 232, IPCP (Internet protocol control protocol) 234, LCP (link control protocol) 236 and PPP (point to point protocol) 238 on the link layer 202; RLP (radio link protocol) 240 and TS-95-A (TIA interim standard for Mobile Station-Base Station Compatibility Standard for Wideband Cellular Systems) 242 over Uₘ 201. The BS/MSC protocol stack 246 comprises IS-95-A 248, RLP 250 and a relay layer protocol 254 and relay layer 252 on the link layer 202. The IWF protocol stack 256 comprises a relay layer protocol 258 on the relay layer 201; PPP 260, LCP 262, IPCP 264 and SNDCF 266 on the link layer 202; IP 268 on the network layer 204; ICMP 270 and TCP 272 on the transport layer 206; a relay 276 and an application interface 278 on the application layer 208; and terminating on a data or fax modem connection to the PSTN 280. The RAS stack 290 comprises a PSTN data modem protocol 284 on the relay layer 201, link layer 202, network layer 204 and transport layer 206: PPP 286 and IP 288 on the application layer 209. The TE2 210 communicates MT2 218 via the Rₘ interface 117. The MT2 218 communicates with the BS/MSC protocol stack 246 via the Uₘ interface 113. The BS/MSC communicates with the IWF 256 via the L-interface 121. The IWF 122 communicates with the RAS 126 via the Aᵢ interface 129.

A mobile originated data only session can be made directly to the Internet. In this scenario, referring to FIG. 1A, the MSC 101 circuit switched data from the MS/BSC 114/104 to the IWF 122. Instead of the IWF 122 modulating the data through a modem 123 to go through the PSTN 124 to the RAS 126, the IWF 122 allows direct connection via QNC 127 to the Internet 128. This is a packet data call to the Internet 128 (no modems or PSTN connection). However, the path from the BSC 104 to the Internet 128 via the IWF 122 is circuit switched through the MSC 101. This provides a pipe to the IWF 122 and also allows for mobility between BTSs 106, BSCs 104 or MSCs 101 without disruption of the data session.

For the BSC 104, the role in terms of power control, mobility and call setup remain the same as with voice. However the processing of the bearer path is significantly different. For voice, the BSC 104 receives PCM (pulse code modulation) encoded voice from the MSC 101 and trans-codes the voice into a format to be transmitted over the air. The format is negotiated upon call setup and is referred to as the service option for the call. The popular service options in use today include the 13K service option which encodes/decodes voice at 14.4 kbs to/from 64 kbs PCM and EVRC (enhanced variable rate codec) that runs at 9.6 kbs, With data, the BSC 104 and MS 114 use a service option to indicate that the call will be data or fax. However, the BSC 104 receives data from the IWF 122 via the MSC 101 (circuit switched). The data is not trans-coded though. Rather the BSC 104 runs a protocol called RLP (Radio Link Protocol) with the MS 114. This layer 2 protocol uses retransmission schemes to reduce error rates and ensure the integrity of the data transferred over the air between the MS 114 and the BSC 104. At the MS 114 the RLP frames are passed up the protocol stack once received. Similarly, the ESC 104 transmits data received from the MS 114 through a relay protocol such as, for example, ISLP (inter-system link protocol) to the IWF 122.

Hence the MS 114 establishes an end to end connection with the IWF 122 using RLP between the MS 114 and BSC 104 and ISLP between the BSC 104 and IWF 122. However, at higher levels, referring to FIGS. 1A and 2, the MS 114 and IWF 122 negotiate a TCP 226,272 /IP 230,268 /PPP 238,260 session for communication with the IWF 122. With the connection of the terminal equipment (TE2 118, a PC for example) an end to end IP 212,288 /PPP 213,286 connection is negotiated between the TE2 118 and the RAS 126. For example, a PC dials-in to a terminal server such as a normal modem.

It is important to note that a modem is not used between the MS 114 and the IWF 122. The actual modem connection is established between the IWF 122 and the RAS 126 through the PSTN 124. Advantageously, the lack of modem allows the MS 114 and the IWF 122 to establish a packet data connection of their own through a circuit connection on the MSC 101. Hence the MS 114 can communicate directly to the Internet 128 via the IWF 122. This service is known as QNC or Fast Connect. This is a packet data connection from the MS 114 to the Internet 128. It just happens to be carried through the MSC 101 circuit connection to get to the IWF 112 and deal with mobility.

With the introduction of higher-speed traffic channels in IS-2000, a new high-speed packet data service option (IS-707-A-1.12) was defined which supports burst data rates of up to 153.6 kbps (in the initial release). Unlike the CSD service option, this service option was intended to support IP access directly. The protocol stack for this service option is shown in FIG. 3.

Referring to FIG. 3, a protocol stack model for a 3G CDMA mobile communication system offering high-speed packet data services 300 comprises a TE2 protocol stack 308, an MT2 protocol stack 318, a BS/PCF protocol stack 328 and a PDSN protocol stack 342. The protocol stack model for a 3G CDMA mobile communication system 300 also comprises a relay layer 301, a link layer 302, a network layer 304 and an upper layer protocols layer 306. The TE2 protocol stack 308 comprises upper layer protocols 310 on the upper layer protocol layer 306, IP 312 on the network layer 304, PPP 314 on the link layer 302 and Rₘ relay layer protocol 316 on the relay layer 301 over Rₘ 117. The MT2 protocol stack 318 comprises Rₘ relay layer protocol 320 over Rₘ 11-7, Lₘ link layer protocol 324 and airlink 326 on Uₘ 115; and L2 relay 322 on the link layer 302. The BS/PCF protocol stack 328 comprises airlink protocol 330, Lₘ link layer protocol 332, A_{quater} network layer protocol 336, A_{quater} link layer protocol 338 and physical layer protocol 340; and L2 relay 334 on the link layer 302. The PDSN protocol stack 342 comprises a physical layer protocol 344, A_{quater} link layer protocol 346 and A_{quater} network layer protocol 348 on the relay layer 301; PPP 350 on the link layer 302; IP 352 on the network layer 304; and upper layer protocols 354 on the upper layers 306. The relay layer 301 of the TE2 protocol stack 308 communicates with the relay layer 301 of the MT2 protocol stack 318 via the Rₘ interface 117. The relay layer 301 of the MT2 protocol stack 218 communicates with the relay layer 301 of the BS/PCF protocol stack 328 via the Uₘ interface 115. The relay layer 301 of the BS/PCF protocol stack 328 communicates with the relay layer 301 of the PDSN protocol stack 342 via the R-P interface 119.

In the 3G packet data configuration, the communication paths between the TE2 118 and the network inter-working function (PDSN 120 in this case) is much more direct. As shown in the protocol stack (FIG. 3), the protocol complexity on the terminal has become simpler. The terminal serves to exchange data with the TE2 118 and transmit/receive it over the air. The Airlink 115 in this case is IS-2000 while the Lₘ link layer 324 is provided by RLP as with CSD. The ALP for packet data is changed from RLP-1 for CSD and RLP-3 for 3G to deal with the higher data rates. Another set of protocol stacks (as specified in IS-2001 titled: “Interoperability Specification for CDMA 2000 Access Network Interfaces”) is used to transport data between the BSC/PCF 104,107 and the PDSN 120.

In this configuration the PPP session on the TE2 118 is established with the PDSN 120. Hence PPP frames are in essence directly exchanged. The BSC/PCF 104,107 and MS 114 serve as intermediate relays of the PPP frames.

Referring to FIG. 4, a protocol Stack model of the preferred embodiment of the invention 400 comprises a TE2 protocol quack 416, an MT2 protocol stack 426, a BS/PCF protocol stack 450 and a PDSN protocol stack 462. The protocol stack model for a mixed 2G/3G CDMA mobile communication system 400 also comprises a relay layer 401, a IS-707-A.4 link layer 402, a IS-707-A.4 network layer 404, a IS-707-A.4 transport layer 406, and application layer 408, a IS-707-A-1.12 PDSN link layer 410, a IS-707-A-1.12 network layer 412 and an upper layer 414. The TE2 protocol stack 416 comprises upper layer protocols 418 on the upper layer 414, IP 420 on the IS-707-A-1.12 network layer 412, PPP 422 on the Its IS-707-A-1.12 PDSN link layer 410 and RS-232 424 on the application layer 408, IS-707-A.4 transport layer 406, IS-707-A.4 network layer 404, IS-707-A.4 link layer 402 and relay layer 401. The MT2 protocol stack 426 comprises RS-232 428 on the application layer 409, IS-707-A.4 transport layer 406, IS-707-A.4 network layer 404, IS-707-A.4 link layer 402 and relay layer 401; relay 430 on the IS-707-A-1.12 PDSN link layer 410; an application interface 432 on the application layer 408, TCP 434 and ICMP 436 on the IS-707-A.4 transport layer 406; IP 438 on the IS-707-A.4 network layer 404; IPCP 440, SNDCF 442 and PPP 444 on the IS-707-A.4 link layer 402; RLP 446 and IS-95 448 on the relay layer 401. The BS/PCF protocol stack 450 comprises IS-95 452, RLP 454, A_{quater} 458 and PHYS 460 on the relay layer 401 and relay 456 on the IS-707-A.4 link layer 402. The PDSN protocol stack 462 comprises PHYS 464 and A_{quater} 466 on the relay layer 401; PPP 468, IPCP 470 and SNDCF 472 on the IS-707-A.4 link layer 402; IP 474 on the IS-707-A.4 network layer; ICMP 476 and TCP 478 on the IS-707-A.4 transport layer; an application interface 480 on the application layer 408; PPP 492 on the IS-707-A1.12 PDSN link layer 410, IP 484 on the IS-707-A-1.12 network layer 412; and upper layer protocols on the upper layer 414.

The relay layer 401 of the TE2 protocol stack 418 communicates with the relay layer 401 of the MT2 protocol stack 426 via the Rₘ interface 117. The relay layer 401 of the MT2 protocol stack 426 communicates with the relay layer 401 of the BS/PCF protocol stack 450 via the Uₘ interface 113. The relay layer 410 of the BS/PCF protocol stack 450 communicates with the relay layer 401 of the PDSN protocol stack 462 via the R-P interface 119.

Referring to FIG. 5, a protocol stack model for an alternative embodiment of the invention 500 comprises a TE2 protocol stack 508, an MT2 protocol stack 519, a BS/MSC protocol stack 528 and a PDSN protocol stack 538. The protocol stack model for a mixed 2G/3G CDMA mobile communication system 500 also comprises a relay layer 502, a link layer 503, a network layer 504 and an upper layer 506. The TE2 protocol stank 508 comprises upper layer protocols 510 on the upper layer 506, network layer protocols 512 on the network layer 504, PPP 514 on the link layer 503 and EIA-232 516 on the relay layer 502. The MT2 protocol stank comprises EIA-232 520, RLP 524 and IS-95 526 on the relay layer 502,; and L2 relay 522 on the link layer. The BS/MSC protocol stack comprises IS-95 530, RLP 532, A_{quater} network layer protocol 336, A_{quater} link layer protocol 338 and physical layer protocol 340 on the relay layer 502. The PDSN protocol stack 538 comprises a physical layer protocol 344, A_{quater} link layer protocol 346, A_{quater} network layer protocol 348 on the relay layer 502; PPP 542 on the link layer 503, network layer protocols 544 on the network layer 504 and upper layer protocols 546 on the upper layers 506. The relay layer 502 of the TE2 protocol stack 508 communicates with the relay layer 502 of the MT2 protocol stack 518 via the Rₘ interface 117. The relay layer 502 of the MT2 protocol stack 518 communicates with the relay layer 502 of the BS/MSC protocol stack via the Uₘ interface 113. The relay layer 502 of the BS/MSC protocol stack communicates with the relay layer 540 of the PDSN protocol stack 538 via Aquater 119.

The invention allows an MS 114 to traverse the boundary of 3G IS-2000 coverage without experiencing disruptions in the PPP layer, thus allowing continuity of the user's application. This is done through the following method that is summarized in the flow chart of FIG. 6A. This method is applicable to the architecture shown in FIG. 1A and 1B. The BSC 104 determines that the MS 114 is departing from the IS-2000 coverage area 112 (Step 602). This is done using existing mechanisms used to trigger handoffs in the CDMA network. If the MS 114 is not leaving the IS-2000 coverage area 112 then IS-2000 coverage continues (Step 604).

As the MS 114 approaches the coverage boundary 109 it will, as part of normal IS-2000 soft handoff procedures, report the identity (PN (pseudorandom noise) offset) and pilot channel signal strength of adjacent cells in a Pilot Strength Measurement Message to the BTS 108. Alternatively, the BSC 104 can determine via exiting mechanisms that the MS 114 is nearing the boundary. The BSC 104 receives this message from the BTS 108 and compares the reported PN offsets to the cell/neighbor database 105 to determine the possible candidate target cells for soft handoff. The cell/neighbor database 105 includes information as to whether the target cells can support the IS-2000 traffic channels (Step 606). If one or more of the target cells can support IS-2000 traffic channels then continue with the standard handoff procedure (Step 608). If none of the suitable target cells can support IS-2000 traffic channels, then the BSC 104 concludes that the mobile is leaving the IS-2000 coverage area 112, and that the BSC 140 must switch the call to an IS-95 traffic channel.

Alternatively, the BSC 104 need not know beforehand whether the target cell 110 can support IS-2000 traffic channels. The BSC 104, as part of the soft handoff procedure, requests an IS-2000 traffic channel from the target cell 110. The target cell 110 responds that it cannot provide an IS-2000 traffic channel either explicitly or implicitly (by using a message format that only applies to IS-95 traffic channels). In either case, the BSC 104 concludes that it must switch the call to an IS-95 traffic channel.

Since the call must be switched to an IS-95 traffic channel, and since the high-speed packet data service option is not supported on IS-95 traffic channels, the BSC 104 concludes that it must switch the call from the high-speed packet data service option to the CSD service option. This is performed using existing service negotiation or service option negotiation procedures, as described in the IS-95, IS-2000, and IS-707-A standards. The BSC 104 proposes to the MS 114 that the existing packet data service option be ended, and a new CSD service option be connected (Step 610). If the MS 114 cannot accept the service option change (Step 611) then no further action is taken by the BSC 104. The coverage fades and the call is dropped and the work of step 615 is undone (Step 612). if the MS 114 can accept the service option change, the BSC 104 instructs the MS 114 to release the existing IS-2000 physical channel(s) and replace them with IS-95 physical channel(s) (step 613). This latter step can be performed as part of the handoff procedure.

Assuming the MS 114 accepts the change of service option, it performs any required initialization of the RLP 446, PPP 444, IP 438, TCP 434, and application interface 432 layers according to IS-707-A.4 without, it disturbing the Rₘ interface 117 relay layer 401 (Step 614). In the 3G protocol stack model 300, the TE2 PPP layer 314 rides on top of the Rₘ relay layer 316. As long as this layer is not disturbed, there should be no impact to the user's PPP 314, IP 312, or upper-layer protocols 310.

While the BSC 104 is in the process of commanding the MS 114 to switch from 3G service to 2G service, it signals to the PDSN 120 (via the R-P interface 119) that it must alter the protocol stack used on the R-P interface 119 to carry the user's PPP frames (Step 615). This requires new signalling messages on the R-P interface. For example, the BSC 104 sends the PDSN 120 an Incoming Call Request (ICRO) L2TP message with a new attribute value pair (AVP) indicating that the existing user session (referred to as a call in the L2TP standard) should be switched to the IS-707-A.4 protocol stack, while preserving the TE2 118 to PDSN 120 PPP connection.

Alternatively, for networks employing the standardized IS-2001 A₁₀ and A₁₁ protocols on the R-P interface 119, extensions to the A₁₀ and A₁₁ are used to provide this information. For example, the BSC/PCF 104/107 sends an A₁₁ Registration Request message modified to include an information element to indicate that the existing user session should be switched to the IS-707-A.4 protocol stack, while preserving the TE2 118 to PDSN 120 PPP connection.

Once this signalling transaction on the R-P interface 119 is completed, the BSC 104 switches the radio (Uₘ) interface relay layer 113, which had previously been using the RLP-3 protocol (per IS-707-A-1.10), to the RLP-1 protocol (per IS-707-A.2) (Step 616). The BSC 104 continues to relay the content of RLP frames to the PDSN 120 over the R-P interface 119.

The PDSN 120 proceeds to initialize the IS-707-A.4 relay 401, link 402, network 404, transport 406, and application interface 408 layers according to IS-707-A.4. Once initialized, the PDSN 120 delivers the user PPP data destined for the TE2 118 (the IS-707-A-1.12 link layer 410 data) to the IS-707-A.4 application interface layer's application 480. User PPP data arriving from the TE2 118 is delivered by the IS-707-A.4 application layer interface 480 in the PDSN 120 to the IS-707-A-1.12 link layer 402 (Step 618). Note that there are essentially two link layers in operation at this point: the IS-707-A.4 link layer 410 between the Mobile Station's MT2 116 and a virtual IWF in the PDSN 120, and what was originally the IS-707-A-1.12 link layer 402 between PDSN 120 and the Mobile Station's TE2 118.

The latter consists of a PPP connection, which from the point of view of the IS-707-A.4 service option is now considered application data. The switch to IS-95 coverage is complete (step 620).

Note that at this point, it is not possible to handoff the data session to Another PDSN. If the user should be handed-off to another system that doesn't have connectivity to the existing PDSN 120, the data session must be released.

Advantageously, this procedure can be performed in reverse when the MS 114 moves from a 2G coverage area 110 into a 3G coverage area 112. This is done though the following method that is summarized in the flow chart of FIG. 6B. The BSC 104 determines that the MS 114 is departing from the current IS-95 coverage area 110 (Step 652). If the MS 114 is not leaving the IS-95 coverage area 112 the IS-95 coverage continues (Step 654). Otherwise, the BBC 104 determines it the new target cell is capable of IS-2000 operation (Step 656). If none of the target cells can support IS-2000 traffic channels then continue with standard handoff method (step 658). The BSC 104 proposes to the MS 114 that the existing CSD service option be ended, and a new packet data service option be connected (Step 660). If the MS 114 can't accept the service option change (Step 661) then continue as a circuit switched data call (Step 662). As well, the work in Step 665 is undone. Otherwise, the BSC 104 instructs the MS 114 to release the existing IS-95 channel(s) and replace them with IS-2000 channels (Step 663). Otherwise, the BSC 104 indicates that the RLP 446, RLP 444, IP 438, TCP 434, and Application Interface 432 layers should be removed (Step 664). Meanwhile, the BSC 104 signals the PDSN 120 (via the R-P interface 119) that it must alter the protocol stack used on the R-P interface 119 to carry the user's PPP frames (Step 665). Once the R-P interface 119 transaction is complete, the BSC 104 to relay the content of the. RLP-3 frames to the PDSN 120 over the R-P interface 119 (Step 668): The transition to IS-2000 coverage is complete (Step 670). The protocol stack for this service option is shown in FIG. 3.

At this point there is no restriction on inter-system handoff.

Alternatively, instead of switching to CSD, Switch to non-high-speed packet data service option IS-707-A-5. The protocol stack is similar to high-speed packet data service option. The protocol stack for this service option is shown in FIG. 5. This is done through the following method that is summarized in the flow chart of FIG. 6C. This method is similar to the preferred embodiment method of the flow chart shown in FIG. 6A except for the following changes. In Step 610 a new 2G packet data option is proposed. Step 615 is not performed. In Step 614 RLP 446 is initialized without disturbing the Rₘ interface 117 relay layer. In Step 618 the PDSN 120 delivers the uses PPP data destined for the TE2 118 (the IS-707 link layer 542 data) to the BS/PCF 104,107. The user PPP data arriving from the TE2 118 is delivered by the PDSN 120 to the TS-707 BS/PCF 104/107 to link layer 542.

Those skilled in the art should also appreciate that in some embodiments of the invention, all or part of the functionality previously described herein with respect to the invention may be implemented as pre-programmed hardware or firmware elements (not shown) such as application specific circuits, erasable programmable read-only memories or other similar components. Such pre-programmed hardware or firmware elements may reside, for example, in the BS 103, the MS 114, the MSC 101 or the PDSN 120.

In other embodiments of the invention, all or of the functionality previously described herein with respect to the invention may be implemented as software consisting of a series of instructions for execution by a computer system or multiple computer systems. Such computer systems may reside, for example, in the BS 103, the MS 114, the MSC 101 or the PDSN 120.

The series of instructions could be stored on a medium that is readable directly by the computer system (such as a removable diskette, CR-ROM, ROM or fixed disk) or the instructions could be stored remotely but transmittable to the computer system via a modem or other interface device connected to a network over a transmission medium.

While the preferred embodiment of the present invention has been described and illustrated, it will be apparent to persons skilled in the art that numerous modifications and variations are possible. The scope of the invention, therefore, is only to be limited by the claims appended hereto.

1. In a CDMA (code division multiple access) communication system having a base station controller (BSC), a mobile station (MS) and a plurality of base station transceivers (BTS) with at least one BTS providing an area of non-high-speed data coverage and at least one BTS providing an area of high-speed data coverage, a method for switching a high-speed data packet data call to a non-high-speed data circuit switched data call, the method comprising the steps of:
identifying that the MS is exiting an area of high-speed data coverage and entering an area of non-high-speed data coverage;
negotiating service options between the MS and the BSC; and
switching from high-speed packet data service option to non-high-speed data circuit switched data service option.

2. The method of claim 1 wherein the area of high-speed data coverage is an area of IS-2000 coverage and the area of non-high-speed data coverage is an area of IS-95 coverage.

3. The method of claim 1 wherein the step of negotiating service options between the MS and the BSC comprises the BSC proposing to the MS that the existing high-speed data packet data service option be ended and a new non-high-speed data circuit switched data service option be connected.

4. The method of claim 3 further comprising the step of determining whether the MS can accept the service option change.

5. The method of claim 4 further comprising the step of the BSC instructing the MS to release high-speed data physical channels and replace them with non-high-speed data physical channels.

6. The method of claim 5 wherein the communication system has a radio interface relay layer, further comprising the step of switching the radio interface relay layer to RLP-1 protocol.

7. The method of claim 6 wherein the MS has an MT2 (mobile terminal) having a relay layer, an RLP (radio link protocol), a PPP (point-to-point protocol), an IP (internet protocol), a TCP (transport control protocol) and an application interface layer, further comprising the step of initializing the RLP, PPP, IP, TCP and the application interface layers such that the relay layer of the MT2 is not disturbed.

8. The method of claim 1 wherein the communication system has a PDSN (packet data support node) connected to the BSC via an R-P interface and wherein the step of negotiating service options between the MS and the BSC further comprises the step of the BSC signalling to the PDSN via the R-P interface that it must alter the protocol stack used on the R-P interface.

9. The method of claim 1 wherein the communication system has a PDSN with a PDSN link layer and an application interface layer Application and wherein the MS has a TE2 link layer wherein the step of switching from high-speed data packet data service option to non-high-speed data circuit switched data service option comprises the step of the PDSN delivering data destined for the TE2 link layer to the application interface layer application and data arriving from the TE2 being delivered by the application layer interface in the PDSN to the PDSN link layer.

10. A CDMA (code division multiple access) communication system comprising:
a base station controller (BSC);
a mobile station (MS);
a plurality of base station transceivers (BTS) with at least one BTS providing an area of non-high-speed data coverage and at least one BTS providing an area of high-speed data coverage;
means for identifying that the MS is exiting an area of high-speed data coverage and entering an area of non-high-speed data coverage;
means for negotiating service options between the MS and the BSC; and
means for switching from high-speed data packet data service option to non-high-speed data packet data service option.

11. The CDMA communication system of claim 10 wherein the are of high-speed data coverage is an area of IS-2000 coverage and the area of non-high-speed data coverage is an area of 1S-95 coverage.

12. The CDMA communication system of claim 10 wherein the means for negotiating service options between the MS and the BSC comprises means for the BSC proposing to the MS that tho existing high-speed data packet data service option be ended and a new non-high-speed data circuit switched data service option be connected.

13. The CDMA communication system of claim 12 further comprising means to determine whether the MS can accept the service option change.

14. The CDMA communication system of claim 13 further comprising means to have the BSC instruct the MS to release high-speed data physical channels and replace them with non-high-speed data physical channels.

15. The CDMA communication system of claim 14 further comprising:
a radio interface relay layer; and
means to switch the radio interface relay layer to RLP-1 protocol.

16. The CDMA communication system of claim 15 further comprising:
a TE2 (terminal equipment) in the MS;
an MT2 (mobile terminal) with a relay layer;
an RLP (radio link protocol);
a PPP (point-to-point protocol);
an IP (internet protocol);
a TCP (transport control protocol);
an applications interface layer; and
means for initializing the RLP, PPP, IP, TCP and the application interface layer such that the relay layer of the M2 is not disturbed.

17. The CDMA communication system of claim 10 wherein the means for negotiating service options between the MS and the RS further comprises:
a PDSN (packet data support node) connected to the BSC via an R-P interface; and
means to have the BSC signal to the PDSN via the R-P interface that it must alter the protocol stack used on the R-P interface.

18. The CDMA communication system of claim 10 further comprising:
a PDSN with a PDSN link layer;
an application interface layer application;
a TE2 link layer in the MS; and
the means for switching from high-speed data packet data service option to non-high-speed data circuit switched data service option further comprising means for the PDSN delivering data destined for the TE2 link layer to the application interface layer application and data arriving from the TE2 being delivered by the application layer interface in the PDSN to the PDSN link layer.

19. In a CDMA (code division multiple access) communication system having a base station controller (BSC), a mobile station (MS) and a plurality of base station transceivers (BTS) with at least one BTS providing an area of non-high-speed data coverage and at least one STS providing an area of high-speed data coverage, a method for switching a non-high-speed data circuit switched data call to a high-speed data packet data call, the method comprising the steps of:
identifying that the MS is exiting an area of non-high-speed data coverage and entering an area of high-speed data coverage;
negotiating service options between the MS and the BSC; and
switching from non-high-speed data circuit switched data service option to high-speed packet data service option.

20. The method of claim 19 wherein the area of high-speed data coverage is an area of IS-2000 coverage and the area of non high-speed data coverage is an area of IS-95 coverage.

21. The method of claim 19 wherein the step of negotiating service options between the MS and the BSC comprises the BSC proposing to the MS the existing non-high-speed data circuit switched data service option be ended and a new high-speed data packet data service option be connected.

22. The method of claim 21 further comprising the step of determining whether the MS can accept the service option change.

23. The method of claim 22 further comprising the step of the BSC instructing the MS to release non-high-speed data physical channels and replace them with high-speed data physical channels.

24. The method of claim 22 wherein the communication system has a PDSN (packet data support node) connected to the BSC via an R-P interface, further comprising the step of the BSC signalling to the PDSN via the R-P interface that it must alter the protocol stack used on the R-P interface.

25. The method of claim 23 wherein the MS has an MT2 (mobile terminal) having a relay layer, an RLP (radio link protocol), a PPP (point-to-point protocol), an IF (internet protocol), TCP (transport control protocol) and an application interface layer, further comprising the step of removing the RLP, PPP, IP, TCP and the application interface layer such that the relay layer of the MT2 is not disturbed.

26. The method of claim 19 wherein the communication system has a PDSN connected to the BSC via an R-P interface, the MS has an MT2 having an RLP wherein the step of switching from non-high-speed data circuit switched data service option to high-speed data packet data service option comprises the step of the BSC continuing to relay the content of RLP frames to the PDSN over the R-P interface.

27. A CDMA communication system comprising;
a base station controller (BSC);
a mobile station (MS);
a plurality of base station transceivers (BTS) with at least one BTS providing an area of non-high-speed deed coverage and at least one BTS providing an area of high-speed data coverage;
means for identifying that the MS is exiting an area of non-high-speed data coverage and entering an area of high-speed data coverage;
means for negotiating service options between the MS and the BSC; and
means for switching from non-high-speed data circuit switched data service option to high-speed packet data service option.

28. The CDMA communication system of claim 27 wherein the area of high-speed data Coverage is an area of IS-2000 coverage and the area of non-high-speed data coverage is an area of IS-95 coverage.

29. The CDMA communication system of claim 27 wherein the means for negotiating service options between the MS and the BSC comprises means for the BSC proposing to the MS the existing non-high-speed data circuit switched data service option be ended and a new high-speed data packet data service option be connected.

30. The CDMA communication system of claim 29 further comprising means for determining whether the MS can accept the service option change.

31. The CDMA communication system of claim 30 further comprising means for the BSC instructing the MS to release non-high-speed data physical channels and replace them with high-speed data physical channels.

32. The CDMA communication system of claim 27 further comprising:
a PDSN (packet data support node) connected to the BSC via an R-P interface; and
means for the BSC signalling to the PDSN via the RP interface that it must alter the protocol stack used on the R-P interface.

33. The CDMA communication system of claim 31 wherein the MS has an MT2 (mobile terminal) having a relay layer, an RIP (radio link protocol), a PPP (point-to-point protocol), an IP (internet protocol), TCP (transport control protocol) and an application interface layer, further comprising means for removing the RLP, PPP, IP, TCP and the application interface layer such that the relay layer of the MT2 is not disturbed.

34. The CDMA communication system of claim 27 wherein the communication system has a PDSN connected to the BSC via an R-P interface, the MS has an MT2 having an RLP wherein the means for switching from non-high-speed data circuit switched data service option to high-speed data packet data service option comprises means for the BSC continuing to relay the content of RLP frames to the PDSN over the R-P interface.

35. In a CDMA (code division multiple access) communication system having a base station controller (BSC), a mobile station (MS) and a plurality of base station transceivers (BTS) with at least one BTS providing an area of non-high-speed data coverage and at least one BT3 providing an area of high-speed data coverage, a method for switching a high-speed data packet data call to a non-high-speed data packet data call, the method comprising the steps of:
identifying that the MS is exiting an area of high-speed data coverage and entering an area of non-high-speed data coverage;
negotiating service options between the MS and the BSC; and
switching from high-speed packet data service option to non-high-speed data packet data service option.

36. The method of claim 35 wherein the area of high-speed data coverage is an area of IS-2000 coverage and the area of non-high-speed data coverage is an area of IS-95 coverage.

37. A CDMA (code division multiple access) communication system comprising:
a base station controller (BSC);
a mobile station (MS);
a plurality of base station transceivers (BTS) with at least one BTS providing an area of non-high-speed data coverage and at least one BTS providing an area of high-speed data coverage;
means for identifying that the MS is exiting an area of high-speed data coverage and entering an area of non high-speed data coverage;
means for negotiating service options between the MS and the BSC; and
means for switching from high-speed data packet data service option to non-high-speed data packet data service option.

38. The CDMA communication system of claim 37 wherein the area of high-speed data coverage is an area of IS-2000 coverage.

39. The CDMA communication system of claim 37 wherein the area non-high-speed data coverage is an area of IS-95 coverage.

40. Computer-readable media embodying a program of instructions executable by a computer to perform a method for switching a high-speed data packet data call to a non-high-speed data circuit switched data call in a CDMA (code division multiple access) communication system having a base station controller (BSC), a mobile station (MS) and a plurally of base station transceivers (BTS) with at least one BTS providing an area of non-high-speed data coverage and at least one BTS providing an area of high-speed data coverage, the method comprising the stops of;
identifying that the MS is exiting an area of high-speed data coverage and entering an area of non-high-speed data coverage;
negotiating service options between the MS and the BSC; and
switching from high-speed packet data service option to non-high-speed data circuit switched data service option.

41. The computer-readable media of claim 40 wherein the area of high-speed data coverage is an area of IS-2000 coverage and the area of non-high-speed data coverage is an area of IS-95 coverage.

42. Computer-readable media embodying a program of instructions executable by a computer to perform a method for switching a non-high-speed data circuit switched data call to a high-speed data packet call in a CDMA (code division multiple access) communication system having a base station controller (BSC), a mobile station (MS) and a plurality of base station transceivers (BTS) with at least one BTS providing an area of non-high-speed data coverage and at least one BTS providing an area of high-speed data coverage, the method comprising the steps of:
identifying that the MS is exiting an area of non-high-speed data coverage and entering an area of high-speed data coverage;
negotiating service options between the MS and the BSC; and
switching from non-high-speed data circuit switched data service option to high-speed packet data service option.

43. The computer-readable media of claim 42 wherein the area of high-speed data conveyed is an area of IS-2000 coverage and the area of non-high-speed data coverage is an area of IS-95 coverage.

44. Computer-readable media embodying a program of instructions executable by a computer to perform a method for switching a high-speed data packet data call to a non-high-speed data packet data call in a CDMA (code division multiple access) communication system having a base station controller (BSC), a mobile station (MS) and a plurality of base station transceivers (BTS) with at least one BTS providing an area of non-high-speed data coverage and at least one BTS providing an area of high-speed data coverage, the method comprising the stops of:
identifying that the MS is exiting an area of high-speed data coverage and entering an area of non-high-speed data coverage;
negotiating service options between the MS and the BSC; and switching from high-speed packet data service option to non-high-speed data packet data service option.

45. The computer-readable media of claim 44 wherein tho area of high-speed data coverage is an area of IS-2000 coverage and the area of non-high-speed data coverage is an area of IS-95 coverage.
